(19) United States
(12) Patent Application Publication
(10) Pub. No.: US 2004/0009809 A1
(43) Pub. Date: Jan. 15, 2004

(54) Method and system for regulating gaming

(76) Inventor: Victor J. Salerno, Henderson, NV (US)

Correspondence Address: Thomas K. Stine, Esq., Wallenstien & Wagner, Ltd., 53rd Floor, 311 South Wacker Drive, Chicago, IL, 60606-6630, US

(21) Appl. No.: 10/195,728

(22) Filed: Jul. 15, 2002

(51) Int. Cl. G06F 17/00

(52) U.S. Cl. 463/25

(57) ABSTRACT

A system and method for regulating the gaming of a wagerer is disclosed. The wagerer is biometrically scanned to determine recognition. The wagerer is only permitted to gamble if the individual's daily expenditures at gambling kiosks does not exceed a predefined limit.

### TECHNICAL FIELD

The present invention relates to a method and system for regulating gaming and in particular for using biometric recognition to govern an individual's expenditures at gambling kiosks.

### BACKGROUND OF THE INVENTION

A kiosk is a generally a small physical structure, frequently including a computer and a screen displaying information. Sophisticated kiosks allow interaction and include touch screens, sound, and motion video. Certain kiosks have also been adapted for gaming. Gambling is permitted only in certain jurisdictions in the United States, as well as other countries. In some areas, kiosk gambling has been limited to a specific value per individual per day.

The present invention is provided to solve this and other problems.

### SUMMARY OF THE INVENTION

It is an object of the invention to provide a method for regulating a wagerer over a period of time.

In accordance with the invention, the wagerer scans his or her biometric feature. The identity of the wagerer is determined from the scanned biometric feature. A period wager limit is compared to the amount of wagers placed by the wagerer over the period and the wagerer is allowed to place a wager only when the total amount of wagers placed by the wagerer over the period is less than the period wager limit.

It is a further object of the invention to provide a system for regulating a wagerer over a period of time.

In accordance with the invention, the system comprises means for biometrically identifying the wagerer and means for calculating an amount wagered by the identified wagerer over the period. The system further comprises means for comparing the amount wagered by the identified wagerer over the period to a period wager limit and means for allowing the wagerer to place a wager only when the amount wagered by the identified wagerer over the period is below the period wager limit.

### BRIEF DESCRIPTION OF THE DRAWINGS

FIG. 1 is a flow chart illustrating the invention.

### DETAILED DESCRIPTION OF THE INVENTION

While this invention is susceptible of embodiment in many different forms, there is shown in the drawing and will herein be described in detail, a preferred embodiment of the invention with the understanding that the present disclosure is to be considered as an exemplification of the principles of the invention and is not intended to limit the broad aspect of the invention to the embodiment illustrated.

In certain jurisdictions, gambling at scattered kiosks is permitted. However, a limit is often placed on how much an individual can wager in a single day. If the kiosks are to be unattended, there is a need for the kiosk to determine who is placing the wager, so that an individual cannot exceed his or her daily limit. In accordance with the invention, the kiosk is equipped with facial recognition technology, or some other biometric device, to accurately discern who is placing the wager.

With this system, a gambling kiosk can have means for biometrically identifying players to ensure that players do not exceed their daily wager limit. The biometric information of a wagerer accurately identifies the gambler placing the wager.

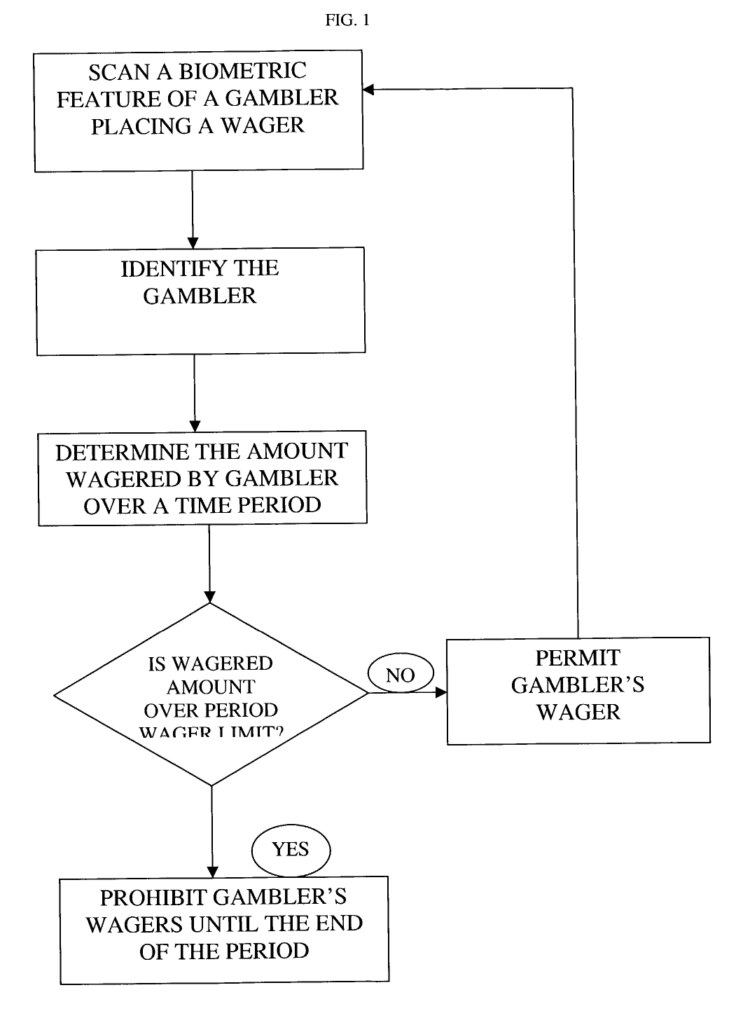

Referring to FIG. 1, a gambler seeking to place a wager first has a biometric feature scanned. The biometric scan identifies the specific gambler. The system then verifies whether the wagered amount exceeds the predetermined wagering amount allowed per gambler over an identified period of time. When the amount wagered by the identified gambler over the period surpasses the period wager limit, then the gambler is prohibited from further wagering. If the total amount wagered by the gambler over the period, including the latest wager sought, is less than the period wager limit, then the wager is permitted or accepted.

While the specific embodiment has been illustrated and described, numerous modifications come to mind without significantly departing from the spirit of the invention, and the scope of protection is only limited by the scope of the accompanying claims.

We claim:

1. A method for regulating a wagerer over a period of time, comprising:
scanning a biometric feature of the wagerer;
determining the identity of the wagerer from the scanned biometric feature;
comparing a period wager limit to an amount of wagers placed by the wagerer over the period; and,
allowing the wagerer to place a wager only when the total amount of wagers placed by the wagerer over the period is less than the period wager limit.

2. A system for regulating a wagerer over a period of time, comprising;
means for biometrically identifying the wagerer;
means for calculating an amount wagered by the identified wagerer over the period;
means for comparing the amount wagered by the identified wagerer over the period to a period wager limit; and
means for allowing the wagerer to place a wager only when the amount wagered by the identified wagerer over the period is below the period wager limit.

3. The method of claim 1 wherein the scanned biometric feature is a facial feature.

4. The method of claim 1 wherein the period is a day.

5. The method of claim 1 wherein the biometric feature scanning occurs in a kiosk.

6. The method of claim 1 wherein the wager is placed at a kiosk.

7. The method of claim 1 wherein the wager is placed to a location remote from the wagerer.
